(19) United States
(12) Patent Application Publication
(10) Pub. No.: US 2007/0024439 A1
(43) Pub. Date: Feb. 1, 2007

(54) Monitoring system for a residence

(76) Inventor: Lee D. Tice, Bartlett, IL (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/189,332

(22) Filed: Jul. 26, 2005

(51) Int. Cl. G08B 1/08; H04Q 7/00

(52) U.S. Cl. 340/539.12

(57) ABSTRACT

A residential monitoring system incorporates a plurality of physiological sensors that can provide information as to the condition of an individual. That information can be coupled to a local computer which can carry out more extensive analysis and engage in more complex interactions with both the individual and a displaced care giver.

### FIELD OF THE INVENTION

The invention pertains to residential monitoring systems. More particularly, the invention pertains to such systems which communicate with a local computer or other communications devices.

### BACKGROUND OF THE INVENTION

Many known in-home monitoring systems use sensors and a control unit that interfaces to a remote location by way of a phone line or wireless medium. The physiological parameters of a patient are measured and the data can be periodically transmitted to the remote location for analysis. This analysis could then be transmitted back to the patient or to other locations. A computer can display compliance information as part of the patient training and encouragement to continue compliance.

Known monitoring systems include those disclosed in Peddicord et al., U.S. Pat. No. 6,402,691 B1 issued Jun. 11, 2002 and entitled, “In-Home Patient Monitoring System”, and, Kiff et al., U.S. patent application Ser. No. 10/956,681 field Oct. 1, 2004 and entitled, “Mobile Telephonic Device and Base Station” assigned to the assignee hereof and, incorporated herein by reference.

It would be desirable to provide enhanced functionality in residential monitoring systems by linking them to local home computers. Since home computers have become quite common, opportunities exist to take advantage of their processing power to run additional and more extensive programs that analyze outputs from physiological sensors. Results of such analysis can be provided to the resident as well as to medical personnel.

### BRIEF DESCRIPTION OF THE DRAWINGS

FIG. 1 is block diagram of a system in accordance with the invention;

FIG. 2 illustrates various aspects and characteristics of usage of the system of FIG. 1.

### DETAILED DESCRIPTION OF THE INVENTION

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

Embodiments of this invention couple a local computer with an in-home monitoring system. The computer can be used to perform to perform the analysis of physiological parameters of the resident. Emergency conditions can be detected. One or more responses can immediately be provided.

Additionally, such systems provide a capability to dispense emergency aid to the resident or take emergency action prior to the arrival of emergency personnel. Such activities are intended to support the resident until emergency personnel arrive at the home to render further aid and/or transport the resident to a hospital.

Systems that embody the invention are advantageous in that they can respond in seconds while it can take several minutes or much longer for emergency personnel to arrive. If there is heavy traffic congestion, it may even take a portion of an hour for help to arrive in some large cities. Time can be very critical to survival in certain health emergency situations.

In addition, since the local computer is available to process the raw physiological data, it can send the data and processing results to a remote monitoring station that has personnel on duty twenty-four hours a day. Local processing provides immediate and more complex diagnostic information to personnel at the remote monitoring site.

In another embodiment, locally generated instructions can be provided to the resident as to immediate actions to take in the event of a medical alert due to abnormalities in the physiology of the resident.

The computer can also be linked to emergency response devices to support and contribute to saving the resident's life. Instructions can be provided as to how to use these devices. These emergency response devices and functions can vary according to the mobility of the resident but can include:

1. Activation of a defibrillator to restore heart rhythm. The resident or another person arriving at the home can attach the pads following appropriate procedures. In another embodiment, the pads can be incorporated into the clothing of the resident. In this configuration they are already coupled to the resident. If the defibrillator is connected to an interface to the computer, the computer can directly initiate a defibrillation process.

2. A medication dispensing container can have a special compartment(s) with predetermined medications for specific emergencies such as heart attack, an abrupt drop in blood pressure, an abrupt increase in blood pressure, or high or low heart rates, etc. Certain residents may have high likelihoods for certain emergencies to take place. As pre-authorized by a doctor, predetermined doses of the medications can be dispensed on an emergency basis while emergency personnel are being summoned to come to the home. These medications would be different than the routine medications that may be dispensed per a scheduled routine.

3. Other devices may also be coupled to or carried by the resident to help maintain his/her life until emergency personnel arrive at the home. For instance, pressure inducing devices could be incorporated into the clothing of the resident. These could inflate during a low blood pressure situation or irregular heart function and help redirect blood in the resident. An example is a pressure device around the upper legs that inflates and reduces blood flow periodically into the legs. Similarly, a pressure device around the upper arms would reduce blood flow periodically into the arms. This then increases blood flow to the head and vital organs to maintain life functions until help arrives.

4. If the resident is in a wheel chair or bed and connected to an IV system, different predetermined medications could be switched and controlled by the computer in response to monitored life functions. The computer could switch over to emergency oxygen if the determined medical condition warrants it or if a primary oxygen tank is running out of gas or malfunctions.

There are many other life saving devices that could be incorporated within embodiments of this invention without departing from the scope of this invention. All such functionality will preferably be associated with an emergency summons for help.

The system may also have safe guards against accidental activation of devices or discharge of predetermined medications. Verification routines can be used to identify the emergency situation and the correct activation.

In another aspect of the invention, communications can be established with a physician prior to activating one or more emergency response life saving devices. The system can communicate results of the analysis of the emergency situation along with proposed actions. This can be accomplished by a pre-arranged agreement wherein the physician has a password or other responses that the system recognizes for authorization to activate the emergency response life saving devices.

Activation of such life saving functions may be with the help of a neighbor who may be the first to respond and could assist by following directions from the system. The computer can provide specific directions that can be followed by an essentially untrained person in performing a life saving function.

In another aspect, the neighbor can be pre-identified, granted immunity from liability, and, pre-authorized to assist. To encourage others to assist in lifesaving actions, a pre-authorized document, pre-approved by the resident can be printed and presented to the person responding to an emergency.

The links between the system components can be supervised to insure a reliable connection and activation. If external devices are coupled by a person, then the coupling can be supervised and verified prior to an activation signal being generated.

In addition to the life saving devices being activated by the computer, the computer can display the vital information to the resident or caregiver that is useful in enhancing the life of the resident. This can include trends in the physiological measurements of the resident. The system can ask the resident questions related to detected changes. For example, if an imbalance trend has started, has the resident recently increased the intake of sugar? Immediate feedback to the resident to alter behaviors that are unbalancing their physiology from their normal level(s).

In yet another aspect, the system can display these trends and emergency response instructions in graphical or written or any visual form. Audio, visual or printouts of information can also be used to help instruct the persons who may be present during an emergency.

The in-home monitoring system can communicate to a remote location using mediums available for data or voice messages. This can include cable, telephone systems or a wireless medium. Other systems including computer networks that provide a communication medium for transmission of data or voice to a location outside the residence call come within the spirit and scope of the present invention.

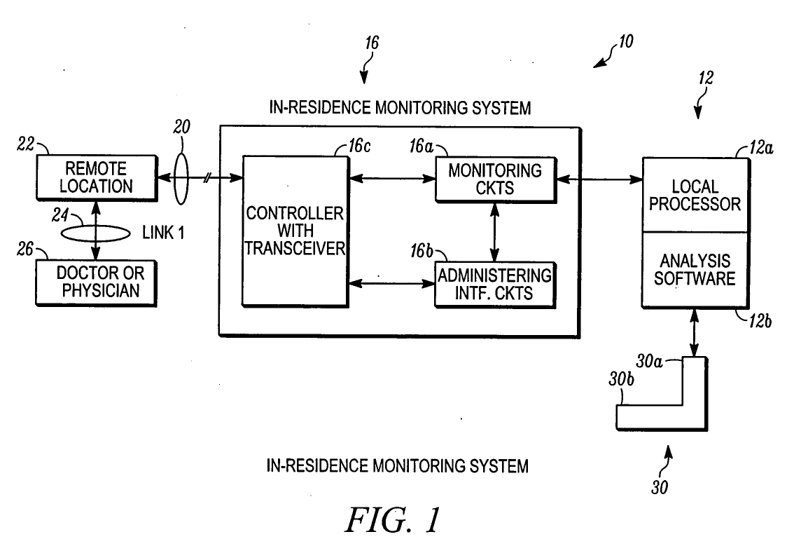

FIG. 1 illustrates a block diagram of a system 10 in accordance with the invention. The system 10 incorporates a local computer, for example, a personal computer of a conventional type 12 which includes a local processor 12a and analysis software 12b.

The analysis software 12b, as those of skill in the art will understand, can process information received from one or more physiological sensors associated with an individual. As discussed subsequently, these could include, without limitation, blood pressure sensors, respiratory sensors, temperature sensors, glucose sensors, cardiac sensors, all without limitation.

Sensors as identified above can be coupled to monitoring circuitry of a conventional type indicated generally at 16. The monitoring system 16 incorporates monitoring circuits 16a to which the above noted sensors would be coupled as well as associated control circuitry. Such circuitry is known from conventional home monitoring systems. The details of such are not limitations of the present invention. System 16 also incorporates administering or output interface circuits 16b which can be coupled to one or more output devices to provide functionality and/or assistance to resident R.

System 16 also includes communications interface circuitry 16c for communicating of via a wired or wireless medium 20 to a remote monitoring location 22. That location which might be a site where nurses and other medical personnel observe and keep track of outputs or reports from the monitoring system 16 could also be in communication via a wired or wireless medium 24 to one or more physicians 26 for receipt of instructions therefrom.

As noted above, the local processor 12a can be in communication with monitoring system 16 for receipt of information received from one or more physiological sensors for monitoring circuitry 16a. Results of analysis carried out by analysis software 12b can be coupled for audible or visual presentation to one or more output devices 30 such as display 30a. The visual or audible output device 30 could be used to present trend or other information to the resident R. Inputs can also be received from the resident via a keyboard, mouse or other input device 30b of a conventional type. If desired, touch screens could also be provided.

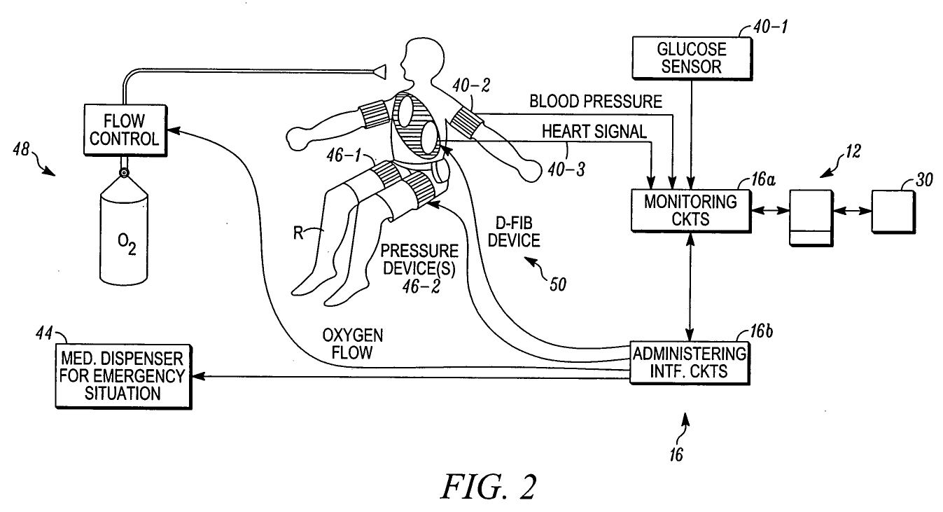

FIG. 2 illustrates one application of a system such as a system 10. A resident R can carry or wear a plurality of physiological sensors such as glucose sensor 40-1, blood pressure sensor 40-2, cardiac monitor 40-3, and the like all without limitation. Outputs from sensors 40-1, -2 . . . -n are coupled to monitoring circuits 16a which in turn communicate with the system 12. System 12 in turn via software 12b, can analyze and provide outputs as to developing trends, or other information of significance from a health point of view based on data received from the monitoring circuits 16a.

For example, where blood pressure sensor 40-2 detects that the blood pressure of the resident R has dropped to a very low value, software 12b can determine that an immediate response is required. As an initial response, monitoring system 16 can initiate a communication via a link 20 to a remote location 22 providing an immediate alert as to a serious low blood pressure condition. One or more monitoring individuals at the location 22 can contact emergency services if appropriate to dispatch an ambulance for a physical intercession with the resident R and also contact the doctor or physician 26 to obtain additional instructions for responding. The physician 26 could also provide authorization codes for carrying out those instructions.

Such instructions could be transmitted to monitoring system 16 which, subject to verification and authorization can, via administering interface circuits 16b activate one or more response devices. These could include dispensing of medication from an emergency medication dispenser 44. Dispenser 44 could be part of a routine medication dispenser or a separate unit.

Circuitry 12b could also activate additional output devices such as periodically activating pressure devices such as 46-1, 46-2 which could be coupled to the resident's legs or arms as appropriate for the purpose of constricting blood vessels temporarily. Periodic activation thereof can restrict temporarily blood flow in to the legs and arms and thereby directing it in to the resident's core organs and brain. Further, the system 16 can couple in additional instructions to system 12 for presentation on display 30a to the resident R to provide follow-up both for the resident R as well as the response personnel who arrive at the residence.

Other outputs include a source of oxygen indicated generally at 48 as well as resident worn defibrillation device 50. As will be understood by those of skill in the art all of the devices 44-50 can operate under the control of interface circuits 16b. As those of skill in the art will understand the various devices 44-50 would be activated only in the presence of predetermined conditions as established via system 12, 16 and in response to instructions received via a link 20.

It is will be understood that other sensors or output devices could be incorporated in the system 10 without departing from the spirit and scope of the invention. To control or limit access to systems 12, 16 software to detect and respond to multi-level authorization codes can be incorporated.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed is:

1. An apparatus comprising:
control circuitry
a plurality of physiological sensors that sense respective parameters of an individual, each of the sensors is coupled to the control circuitry with outputs from respective of the sensors stored, at least temporarily, at the control circuitry, the control circuitry including an output port and,
a programmable processor with an input port and system software, the processor receives at least intermittently sensor output data, via the input port from the control circuitry, the processor and software analyze at least portions of received data relative to the individual's physiological condition;
interface circuitry for communicating results of analyzing portions of received data to at least one other location; and
at least one output device for providing medical assistance to the individual.

2. An apparatus as in claim 1 which includes software to determine at least one physiological trend as a result of analyzing portions of received data.

3. An apparatus as in claim 2 which includes a plurality of output devices for providing medical assistance to the individual.

4. An apparatus an in claim 3 where the plurality includes at least one of a medication dispenser, an oxygen supply, a defibrillator, or blood flow constricting devices.

5. An apparatus as in claim 4 where the plurality of physiological sensors includes at least glucose sensors, blood pressure sensors, temperature sensors, or respiratory sensors.

6. An apparatus as in claim 5 where the control circuitry includes multi-level authorization software responsive to at least one received authorization code.

7. An apparatus as in claim 6 which includes a plurality of pre-stored authorization codes.

8. An apparatus as in claim 6 where in response to a received authorization code, the at least one output device can be activated.

9. An apparatus as in claim 8 where the at least one output device is activated in response to results of analyzing the portions of received data.

10. An apparatus as in claim 9 which includes an output device for providing information to the resident.

11. A monitoring system comprising:
at least one sensor for monitoring a condition of a person and providing at least a first signal;
an interface for transferring the at least a first signal to one of a local device or local personal computer that includes a processor and software to at least in part identify an attention requiring situation determined from the at least a first signal;
at least one of an audio output or visual output to provide treatment information in response to the situation;
the at least one of a local device or personal computer providing an interface for transferring data to and from a remote unit; and
an interface to at least one emergency lifesaving device responsive to the situation.

12. A system as in claim 11 where the emergency output device includes at least one of an emergency medication device, a defibrillation device, a heart pacing device, a pressure inducing device or a pain reduction device.

13. A system as in claim 11 wherein the emergency output device is activated only after a predetermined command message has been received and accepted by at least one of the device or personal computer.

14. A system as in claim 13 where the predetermined command message includes a code to prevent unauthorized persons from generating a predetermined command message that the at least one of the local device or local personal computer will accept and execute.

15. A system as in claim 12 where the pressure inducing device implements a vascular compression.

16. A system as in claim 12 where the pressure inducing device implements an intermittent blood restriction function in response to sensed low blood pressure conditions.

17. A system as in claim 12 where the emergency medication device includes at least one of a predetermined medication, a syringe containing selected medication or an inhalation device.

18. A system as in claim 17 wherein selected information is presented in a graphical form.

19. A system as in claim 11 where the interface for transferring data includes a bus connection.

20. A system as in claim 11 wherein the local device is mounted inside the local computer.

21. A system as in claim 11 where the treatment information includes at least one of charts or trends for measured vital functions.

22. A system as in claim 11 where the treatment information includes emergency actions to be taken in response to the situation.
